(19) United States
(12) Patent Application Publication
(10) Pub. No.: US 2006/0233910 A1
(43) Pub. Date: Oct. 19, 2006

(54) Cartridge heater clamp for mold

(75) Inventors: Michael Wheeler, Clearwater, MN (US); Danny M. Jester, Eden Prairie, MN (US)

Correspondence Address: SHEWCHUK IP SERVICES, 533 77TH STREET WEST, EAGAN, MN, 55121, US

(73) Assignee: The Protomold Company, Inc., Maple Plain, MN (US)

(21) Appl. No.: 11/099,788

(22) Filed: Apr. 6, 2005

(51) Int. Cl. B23P 11/00; B23Q 3/02; B29B 11/06

(52) U.S. Cl. 425/547; 269/97; 29/428

(57) ABSTRACT

A clamp is used to secure a heating element to an outside face of a mold. The clamp includes a frame portion which holds a commercially available cartridge heater. The frame portion is sized to mate with the cartridge heater for efficient conduction heating from the cartridge heater. The clamp attaches to the mold via recesses that can be machined into the mold on a three-axis mill, such as cylindrical opening machined in a direction parallel to and slightly intersecting the side face on which attachment occurs. The clamp includes a biasing mechanism for pressing the clamp into heat conducting contact with the outside face of the mold block to which it is attached, for efficient transfer of heat between the cartridge heater and the mold. The preferred biasing mechanism is through a screw lengthening/shortening mechanism, with the clamp attached on two side faces around a corner of the mold block. The biasing force is enhanced by a fulcrum ledge. By turning the screw and shortening the length between two attachment points, the clamp tightly presses into conducting contact with the mold block.

### CROSS-REFERENCE TO RELATED APPLICATION(S)

None.

### BACKGROUND OF THE INVENTION

The present invention relates to the field of molding. More particularly, the present invention relates to the manufacture and use of injection molds involving heating of at least one of the mold blocks to better manage the flow and solidification of the plastic material within the mold block.

Injection molding, among other types of molding techniques, is commonly utilized to produce plastic parts from molds. Injection molds typically include two plates which are positioned together to form a cavity in which a molten plastic material is injected. The molten plastic material adopts the shape of the cavity and then solidifies. The plates are separated, and the solidified plastic piece is ejected. After ejecting the plastic piece, the plates are again positioned together and the process repeated. Injection molding can be performed thousands of times with the same mold blocks, minimizing the piece price of the resultant parts.

Proper injection molding requires the plastic to flow in its molten state until the cavity is filled, with solidification occurring slowly enough and in such a way as to allow complete filling. At the same time, solidification should occur as quickly as possible, so the part can be ejected as soon as possible, reducing manufacturing time and increasing throughput of parts.

Because the temperature of the plastic and the heat transfer from the plastic are so critical to the speedy production of high quality injection molded parts, many injection mold components include structures to generate or absorb heat. For instance, injection mold nozzles and manifolds often include heating elements. Injection mold blocks have also been heated to better control the solidification of the plastic shot. Some prior mold blocks have included passages for flow of a heat transfer fluid through the mold blocks. The temperature of the heat transfer fluid is maintained external to the mold block, and when the heat transfer fluid is pumped through the mold block it heats (or cools) the mold block to the same temperature as the heat transfer fluid.

Other prior heat control mechanisms for mold blocks involve the use of electrical resistance heater elements. An electrical current is driven through the resistance heater to generate heat within the mold block. A thermostat is used to determine how much current should be driven through the resistance element at any particular time.

One form of such electrical resistance heater elements are cartridge heaters, wherein the resistance element is contained within a housing. The cartridge heater is separate from the mold block. A recess is formed in the mold block to receive the cartridge heater. When using such a cartridge heater arrangement, the same cartridge heater can be readily changed between different mold blocks. If the cartridge heater breaks or malfunctions, it can usually be replaced without affecting any of the mold blocks.

While direct placement of the cartridge heater into the mold block provides these advantages, it also has its disadvantages. The recess for the cartridge heater is positioned in a side wall of the mold block, so the cartridge heater doesn't interfere with the parting line between the two mold block halves. Typically the recess extends perpendicular to the side wall. In such a position, however, machining the recess into the mold block cannot be done with a three-axis CNC mill used to form the cavity and back side detail without reorienting the mold block relative to the mill. Reorienting the mold block in the CNC mill is time consuming, as is machining the recess into the side of the mold block using a different tool.

While the cartridge heater is being used, it can come loose from the mold block. In particular, the injection mold press cycles through opening and closing the mold blocks for each shot, and the vibration and movement can loosen the cartridge heater from its hole. The loose cartridge heater can cause damage or melting of the mold block as it presses harder on one section of the hole than another. If the loose cartridge heater comes partially or fully out of its hole, the hot cartridge heater is dangerous to workers and the injection mold press. Thus, further improvements are needed to the “separate cartridge heater” system of controlling temperature of mold blocks.

### BRIEF SUMMARY OF THE INVENTION

The present invention is a clamp for securing a heating element to an outside face of a mold, and a method of use of such a clamp. The clamp includes a frame portion which holds a commercially available cartridge heater. The clamp attaches to the mold via recesses that can be machined into the mold on a three-axis mill and in an orientation already used in creation of the mold, i.e., machined in a direction parallel to the side face on which attachment occurs, which could be either the direction used in milling the mold cavity or the direction used in machining the back side of the mold. The clamp includes a biasing mechanism for pressing the clamp into heat conducting contact with the outside face of the mold block to which it is attached, for efficient transfer of heat between the cartridge heater and the mold.

### BRIEF DESCRIPTION OF THE DRAWINGS

FIG. 1 is an exploded plan view of a cartridge heater, clamp and mold in accordance with the present invention.

FIG. 2 is a perspective view of the cartridge heater, clamp and mold of FIG. 1 during assembly.

FIG. 3 is cross-sectional view of the cartridge heater, clamp and mold of FIG. 1 after assembly and during use.

While the above-identified drawing figures set forth one or more preferred embodiments, other embodiments of the present invention are also contemplated, some of which are noted in the discussion. In all cases, this disclosure presents the illustrated embodiments of the present invention by way of representation and not limitation. Numerous other minor modifications and embodiments can be devised by those skilled in the art which fall within the scope and spirit of the principles of this invention.

### DETAILED DESCRIPTION

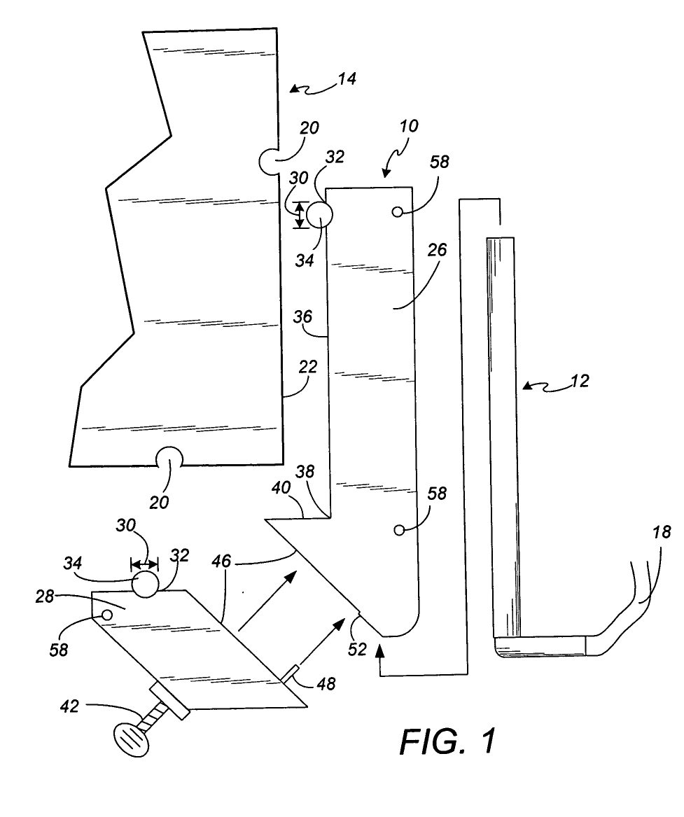

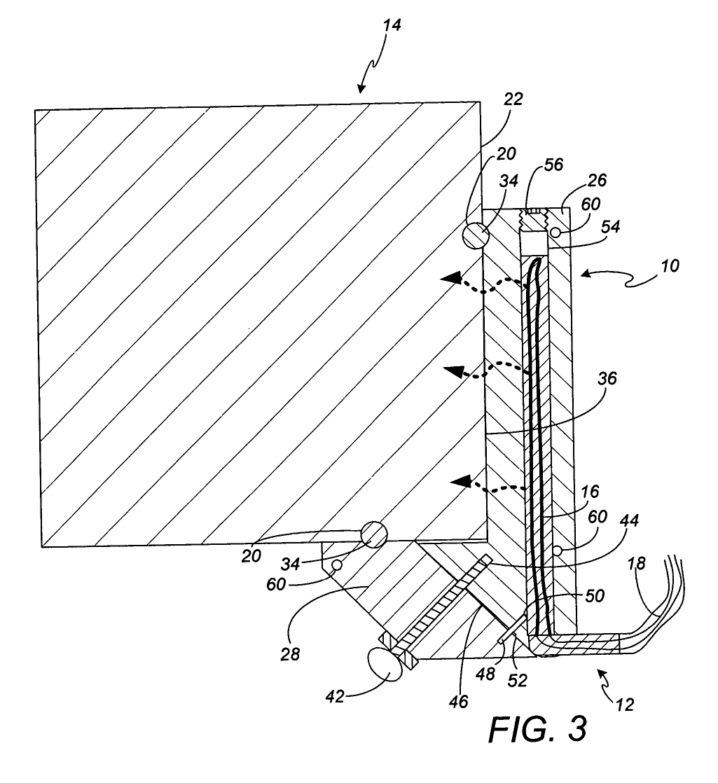

As shown in FIGS. 1-3, a preferred embodiment of the present invention includes a clamp 10 which is used to attach a cartridge heater 12 to a mold block 14. The cartridge heater 12 is within the prior art, and includes a resistance heater element 16 (shown in FIG. 3) within a housing. The heater element 16 is driven by an electrical current through a power cord 18. The housing of one preferred cartridge heater 12 is cylindrical, with a diameter of about ⅜ inch and a length of about 4 inches. Preferably the cartridge heater 12 includes a thermostat to enable temperature regulation. Such cartridge heaters 12 are commercially available such as from Watlow Electric Manufacturing Company of St. Louis, Mo. See for instance U.S. Pat. No. 5,247,158, incorporated herein by reference. Because the clamp 10 is specially designed for the particular type of cartridge heater 12 to be used, virtually any shape or size of cartridge heater 12 could be alternatively used.

The mold block 14 for the invention can be an injection mold block with one or more internal cavities (not separately shown) as known in the art. For instance, typical sizes for mold blocks are 5×5 inches to 10×18 inches, in a rectangular prism shape. Each half of the mold block 14 is about 2 or 3 inches thick. Regardless of the size of the mold block 14, the mold block 14 has been specially modified to mate with the clamp 10 of the present invention. In particular, the mold block 14 includes two recesses 20. In a preferred embodiment, one of the recesses 20 is on an exposed side face 22 of the mold block 14, and the other recess 20 is on a different exposed side face 22 of the mold block 14.

The preferred recesses 20 are cylindrical openings which extend vertically (parallel to the side face 22) and intersect with the side faces 22. A side of the recess 20 which is parallel to its longitudinal axis 24 is exposed on a side face 22 of the mold block 14. The longitudinal axis 24 of each recess 20 is inside the outline of the mold block 14, so the width of the opening formed by the recess 20 is narrower than the diameter of the cylindrical recess 20. This construction makes the recesses 20 very easily machinable. Because the recesses 20 extend vertically, they can be machined with the same three axis CNC mill (not shown) and in the same mold block orientation as is used to machine other portions of the mold 14. For instance, because the recesses 20 extend vertically, they can be machined at the same time and orientation as machining the mold cavity (not shown), or at the same time and orientation as machining features (not shown) on the back side of the mold 14.

While the drawings show a single set of recesses 20, additional sets of recesses could be provided to allow the press operator the option of attaching the clamp 10 in different locations on the mold block 14. The clamp 10 can also be flipped over (show the surface shown on top becomes the bottom), to attach to a mold block in the opposition direction (with the cord 18 coming off the right rather than the left of the clamp 10).

The clamp 10 includes a frame portion 26 that holds the cartridge heater 12, and a tightening portion 28. Each of the frame portion 26 and the tightening portion 28 include a head 30 extending from a neck 32. The head 30 is slightly smaller than the diameter of the recess 20, and the neck 32 is slightly smaller than the width of the recess 20 where it intersects with the side face 22 of the mold block 14. In the preferred embodiment, the head 30 and neck 32 are provided by a cylindrical rod 34 which is permanently joined to the rest of the clamp 10, and each rod 34 is positioned and sized to mate with the respective recess 20 in the mold block 14.

Adjacent the rod 34, the frame portion 26 includes a planar contacting face 36 which in use abuts against the mold 14. The contacting face 36 provides ample smooth surface area for conduction to occur between the frame portion 26 and the mold block 14. In the preferred embodiment, the frame 26 also includes an inside corner 38, with a mold adjacent side face 40 beyond the inside corner 38. This mold adjacent side face 40 is spaced from the rod 34 just enough that the side face 40 doesn't contact the mold block 14 when the rod 34 is in the recess 20, so the shape of the frame portion 26 doesn't interfere with placing the rod 34 into the recess 20.

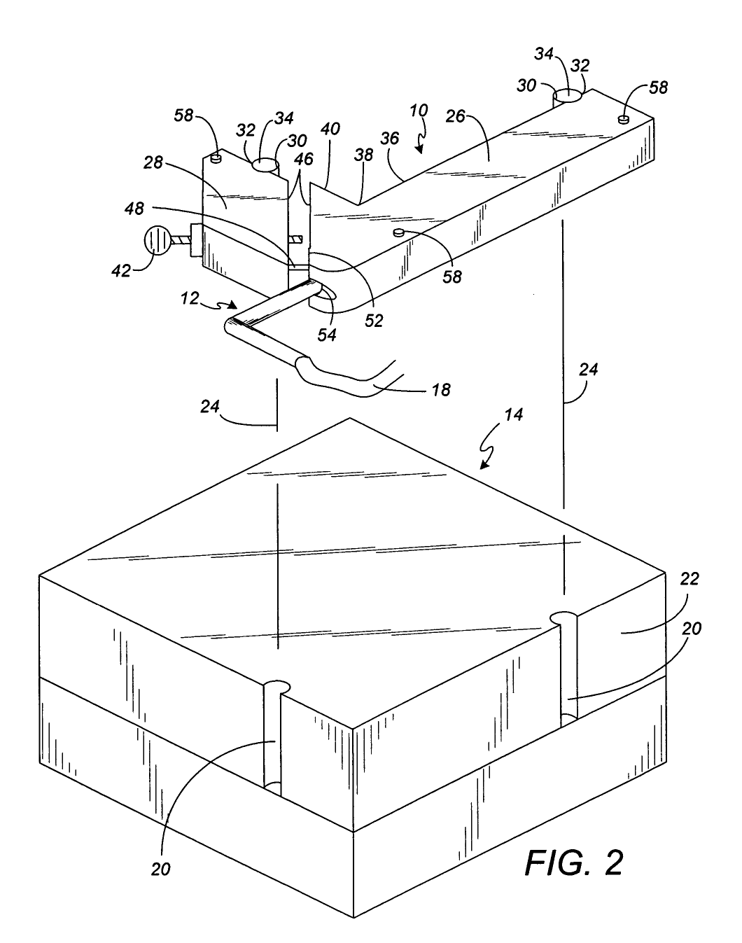

As shown in FIGS. 2 and 3, the tightening portion 28 is removably attachable to the frame portion 26. The tightening portion 28 includes a thumb screw 42 which extends through the tightening portion 28 and into a threaded hole 44 in the frame portion 26. The contacting surface 46 between the frame portion 26 and the tightening portion 28 extends at an angle. The thumb screw 42 is oriented perpendicular to the contacting surface 46. A slide peg 48 projects out of the tightening portion 28 and is received in the frame portion 26. The slide peg 48 assists the user to line up the thumb screw 42 with the thumb screw hole 44. Once the thumb screw 42 is positioned into the thumb screw hole 44, tightening of the thumb screw 42 advances the tightening portion 28 toward the frame portion 26 with the slide peg 48 sliding into the slide peg hole 50. The contacting surface 46 also includes a fulcrum ledge 52.

A through hole 54 is positioned in the frame portion 26. The through hole 54 is sized to mate with the cartridge heater 12. In the preferred embodiment, this mating relationship is a fairly tight fit, so thermal contact is made on all sides of the cartridge heater 12 with the encircling frame portion 26. The opposite end of the through-hole 54 is closed with a set screw plug 56, shown in FIG. 3. The plug 56 can be removed, if necessary, to gain access to the distal end of the cartridge heater 12 and push the cartridge heater 12 out of the through hole 54. Having access to push (rather than pull by the cord end) the cartridge heater 12 out of its hole 54 can be important, particularly if the thermal effects of the cartridge heater 12 cause it to firmly seat in the through-hole 54, or even cause local melting and solidification of the frame portion 26 about the cartridge heater 12.

As shown in FIGS. 1-3, the top side of the clamp 10 includes several set offs 58. Similar set-offs (not shown) are positioned on the bottom side of the clamp 10. In the preferred embodiment, these set offs 58 are simply provided by set screws or cap screws positioned in screw holes 60. The set offs 58 are useful in vertically positioning the clamp 10 relative to the mold block 14 to which it is attached. The set offs 58 also act as a spacer keeping the clamp 10 from touching/conducting heat into the injection press platens (not shown), which could otherwise act as a massive heat sink when the cartridge heater 12 is intended to be heating the mold 14. By having set offs 58 on both the top and bottom of the clamp 10, the clamp 10 can be oriented with either of its major sides facing upward when attached to the mold block 14.

In the preferred embodiment, the mold block 14, the tightening portion 28 and the frame portion 26 are all formed of blocks of metal and particularly blocks of aluminum. Aluminum is readily machined, and has a high heat conductivity. Other metals with high heat conductivity could alternatively be used, such as copper. The rods 34, the set off cap screws 58, the plug set screw 56, and the thumb screw 42 are all formed of steel for strength purposes. The steel has a lower heat conductivity, which is preferred for the set off cap screws 58. The lower heat conductivity is largely inconsequential for the rods 34, the plug set screw 56 and the thumb screw 42. Metals other than steel could alternatively be used.

To use the clamp 10, first the various portions are assembled as illustrated in FIG. 2. The cartridge heater 12 is slid all the way in to the cartridge heater hole 54. The slide peg 48 is inserted into the slide peg hole 50, and the thumb screw 42 is started in the thumb screw hole 44. With the thumb screw 42 still loose, there is some play between the frame portion 26 and the tightening portion 28. With this play, the clamp 10 is positioned onto the mold block 14. The rods 34 are slid down into the recesses 20. When the clamp 10 is at the desired vertical height, the thumb screw 42 is further tightened. This tightening pulls the frame portion 26 tighter and tighter against the mold block 14. The angle of the contacting face 36 and the fulcrum ledge 52 further assist in transferring the force of the thumb screw 42 into a directional orientation that presses the frame portion 26 into tight contact against the mold block 14. In particular, the distance between the two recesses 20 is fixed, while the distance between the two rods 34 can be shortened by tightening the thumb screw 42. The shortening length is achieved by biasing and moving the frame portion 26 toward the mold block 14. While two recesses 20 that were positioned along the same single side of the mold would have some affect in tightening the frame portion 26 against the mold block 14, positioning the recesses 20 on different sides 22 separated by the corner further helps generate a strong force biasing the frame portion 26 against the mold block 14. Thus, a worker can very simply turn the thumb screw 42 to bias the frame portion 26 tightly against the mold block 14. The fulcrum ledge 52 further helps to transfer the pull force of the thumb screw 42 into a force pushing the frame portion 26 into the mold block 14.

If desired, the tight fit between the cartridge heater 12 and cartridge heater hole 54 can be the sole mechanism to hold the cartridge heater 12 in place. However, in the preferred embodiment, once the thumb screw 42 is fully tightened, the edge of the tightening portion 28 extends over the proximal end of the heater cartridge 12 to positively hold the cartridge heater 12 into place in the frame portion 26. The cartridge heater 12 thus cannot be removed from the frame portion 26 without loosening of the thumb screw 42.

Electrical current is driven through the resistance heater element 16 as known in the art, as desired to generate heat. Heat is then conducted as shown by the dashed arrows in FIG. 3, from the resistance heater element 16, through the frame portion 26 and into the mold block 14. The tight contact provided by the clamp 10 between the planar contacting face 36 and the side face 22 of the mold block 14 minimizes thermal resistance to the heat in conducting between the frame portion 26 and the mold block 14.

When molds 14 are being changed in the injection mold press, all that the worker need do is loosen the thumb screw 42 and remove the clamp 10 from the mold 14. Even without fully removing thumb screw 42 from the thumb screw hole 44, the worker can attach the clamp 10 to the new mold 14.

Because the tightening portion 28 holds the cartridge heater 12 into place in the frame portion 26, the prior art problems associated with the cartridge heater 12 coming partially or fully out of the cartridge heater hole are avoided. Further, the cartridge heater 12 need only be changed between frame portions 26 when the cartridge heater 12 fails. Because the cartridge heater 12 is not moved from mold to mold but rather stays protected within the frame portion 26 as the frame portion 26 is moved from mold to mold, the likelihood of damage to the cartridge heater 12 is decreased. Changing the clamp 10 from mold to mold is much simpler than pulling the cartridge heater 12 from its hole and inserting it in a new hole in the new mold.

The recesses 20 for the clamp 10 can be formed in the mold block 14 with the same three axis mill used to machine the cavity or back side detail on the mold, and without reorienting the mold block 14. This shortens the time required for machining of the mold block 14 and lowers costs.

If the cartridge heater 12 does fail during use, the clamp 10 can be quickly removed and replaced with a different clamp/cartridge heater combination. Similarly, if the cartridge heater 12 gets permanently stuck within the cartridge heater hole 54, the stuck cartridge does not affect the mold 14 because the clamp 10 can be quickly removed and replaced with a different clamp/cartridge heater combination.

Although the present invention has been described with reference to preferred embodiments, workers skilled in the art will recognize that changes may be made in form and detail without departing from the spirit and scope of the invention.

1. A clamp for securing a heating element to a mold, the clamp comprising:
a frame having an opening for receiving the heating element;
a mold-engaging head extending from the frame with a neck between the frame and the mold-engaging head, the neck having a thickness less than the head; and
a biasing structuring attachable to the frame for pressing the heating element into conducting contact with the mold.

2. The clamp of claim 1, wherein the frame is formed of a metal block, and wherein the opening is a hole formed in the metal block for encircling engaged contact with the heating element.

3. The clamp of claim 2, wherein the hole extends through the metal block for pushing the heating element back out of the hole.

4. The clamp of claim 2, wherein the metal block is formed of aluminum.

5. The clamp of claim 1, comprising at least two mold-engaging heads spaced apart on the frame by a distance, each mold-engaging head having a neck with a thickness less than the head, wherein the biasing structure permits changing the distance between the mold-engaging heads to generate a biasing force for pressing the heating element into conducting contact with the mold.

6. The clamp of claim 5, wherein the frame extends around a corner, so the two mold-engaging heads engage the mold on different faces about the corner.

7. The clamp of claim 5, wherein the biasing force is provided by a screw.

8. The clamp of claim 1, wherein the mold-engaging head is shaped for mating engagement with a cylindrical recess exposed on a side parallel to a longitudinal axis of the cylindrical recess.

9. The clamp of claim 8, wherein the mold-engaging head is formed of a cylindrical rod joined to the frame.

10. The clamp of claim 9, wherein the cylindrical rod is formed of steel, and wherein the frame is formed of a metal which has a higher heat conductivity than steel.

11. The clamp of claim 1, further comprising:
at least one set-off for separating a face of the clamp from an underlying surface.

12. An external heater for a mold, the external heater comprising:
a heating element disposed within a metal housing;
a planar surface on the metal housing for conducting heat from the heater element to a planar side surface of a mold block; and
an attachment structure extending beyond the planar surface for mating engagement with a recess formed in the mold block.

13. The external heater of claim 12, wherein the heating element is readily removable from the metal housing.

14. The external heater of claim 12, wherein the heating element is cylindrical, and wherein the metal housing comprises a cylindrical hole sized to mate with the heating element in an encircling arrangement.

15. The external heater of claim 12, wherein the attachment structure is readily removable from the recess.

16. A method for biasing a heating element into conducting contact with a mold block, the method comprising:
machining an attachment recess into a mold block with three-axis machining, the attachment recess being exposed on a side face of the mold block, the three-axis machining being oriented in the same direction as three-axis machining used to machine other features into the mold block;
attaching a clamp to the attachment recess, the clamp holding a heating element; and
tightening the clamp to bias the heating element into conducting contact the with mold block.

17. The method of claim 16, wherein the attachment recess is a cylindrical with a side parallel to a longitudinal axis of the cylindrical recess exposed on a side face of the mold block.

18. The method of claim 16 comprising forming at least two attachment recesses spaced apart on the mold block by a distance, with the clamp attaching to both attachment recesses.

19. The method of claim 18, wherein tightening of the clamp comprises changing a clamp length to generate a biasing force for pressing the heating element into conducting contact with the mold.
